(19) United States
(12) Patent Application Publication
(10) Pub. No.: US 2011/0190019 A1
(43) Pub. Date: Aug. 4, 2011

(54) APPARATUS AND METHOD FOR MANAGING SYSTEM FRAME NUMBER IN WIRELESS COMMUNICATION SYSTEM

(75) Inventors: Hyun Bae WOO, Seoul (KR); Jongyeob Kim, Seoul (KR); Hee Keun Song, Anyang-si (KR); Jungjo Hyun, Seoul (KR)

(73) Assignee: Pantech Co., Ltd., Seoul (KR)

(21) Appl. No.: 13/006,238

(22) Filed: Jan. 13, 2011

(30) Foreign Application Priority Data
Feb. 3, 2010 (KR) 10-2010-0009887

(51) Int. Cl. H04B 7/00; H04W 68/00

(52) U.S. Cl. 455/515

(57) ABSTRACT

Provided is an apparatus and a method for managing s system frame number (SFN) in a wireless communication system. A base station allocates information about the SFN to a physical downlink control channel (PDCCH) and transmits the PDCCH, and a mobile terminal reads the PDCCH at each discontinuous reception (DRX) cycle to inspect whether the mobile terminal received a paging message, and determines whether an SFN of the mobile terminal is identical to an SFN of the base station using the information about the SFN included in the PDCCH, thereby solving a difference in SFN.

### CROSS-REFERENCE TO RELATED APPLICATION

This application claims priority from and the benefit under 35 U.S.C. § 119(a) of Korean Patent Application No. 10-2010-0009887, filed on Feb. 3, 2010, which is hereby incorporated by reference for all purposes as if fully set forth herein.

### BACKGROUND

1. Field

Exemplary embodiments of the present invention relate to an apparatus and a method for managing a system frame number (SFN) in a wireless communication system.

2. Discussion of the Background

A mobile terminal performs a discontinuous reception (DRX) operation for is efficient power management. The DRX operation is a power saving technology by waking the mobile terminal at a specific time to inspect whether the mobile terminal has received a paging message. For this purpose, the mobile terminal needs to share a wake-up time of the mobile terminal with a network so that the mobile terminal may normally receive a paging message.

The WCDMA (Wideband Code Division Multiple Access) or LTE (Long Term Evolution) manages an SFN and shares time information between a mobile terminal and a network through the SFN.

The network allocates the SFN to system information and transmits the system information via a PBCH (Primary Broadcast Channel). The mobile terminal obtains the SFN by decoding the PBCH and manages the SFN. The SFN may have a value between 0 and 4095.

Also, the network transmits information indicating that a specific mobile terminal received a paging message at an expected time with the mobile terminal, i.e. at a specific SFN. The network allocates a P-RNTI (Paging Radio Network Temporary Identity) to a PDCCH (Physical Downlink Control Channel), which is a physical channel, and transmits the PDCCH.

The mobile terminal recognizes that the mobile terminal received a paging message through the P-RNTI, and checks paging records by decoding the PDCCH. If identity information in the paging records is the same as identity information of the mobile terminal, an attempt to connect to the network is made.

If this DRX operation causes a problem to SFN management of the mobile terminal, i.e., if a DRX operation is not performed at an accurate timing, the mobile terminal cannot receive a paging message and consequently cannot normally receive a call. Generally, if an error occurs to clock management of a mobile terminal, a difference in SFN occurs between the mobile terminal and a network, and the mobile terminal does not receive a paging message.

### SUMMARY

Exemplary embodiments of the present invention provide an apparatus and a method for managing a system frame number (SFN) in a wireless communication system.

Exemplary embodiments of the present invention provide a method in which a base station of a wireless communication system allocates information about an SFN to a PDCCH (Physical Downlink Control Channel) and transmits the PDCCH.

Exemplary embodiments of the present invention provide a method in which a difference in SFN between a base station and a mobile terminal is checked using information about the SFN included in the PDCCH if the mobile terminal reads the PDCCH in each discontinuous reception (DRX) cycle to inspect whether the mobile terminal received a paging message, and the difference in SFN is solved.

Exemplary embodiments of the present invention provide an apparatus and a method for managing a system frame number (SFN) in a wireless communication system in which the mobile terminal does not receive a paging message assigned to the mobile terminal due to the difference in SFN.

Additional features of the invention will be set forth in the description which follows, and in part will be apparent from the description, or may be learned by practice of the invention.

An exemplary embodiment of the present invention discloses an apparatus to manage an SFN in a mobile terminal, the apparatus including an SFN managing unit to manage an SFN; a physical downlink control channel (PDCCH) reading unit to read a PDCCH and to check information about the SFN included in the PDCCH if waking from a sleep state; and an SFN comparing unit to determine whether the SFN currently managed by the SFN managing unit is identical to an SFN of a network using the information about the SFN.

An exemplary embodiment of the present invention discloses an apparatus to manage an SFN in a base station, the apparatus including a physical downlink control channel (PDCCH) managing unit to check information about an SFN and to transmit the information about the SFN via a PDCCH.

An exemplary embodiment of the present invention discloses a method for managing an SFN in a mobile terminal, the method including reading a physical downlink control channel (PDCCH) if waking from a sleep state; checking information about an SFN included in the PDCCH; and determining whether the SFN currently managed is identical to an SFN of a network using the information about the SFN.

An exemplary embodiment of the present invention discloses a method for managing an SFN in a base station, including checking information about an SFN; and transmitting the information about the SFN via a PDCCH.

An exemplary embodiment of the present invention discloses a wireless communication to manage a system frame number (SFN), the system including a mobile terminal, including: an SFN managing unit to manage an SFN, a physical downlink control channel (PDCCH) reading unit to read a PDCCH and to check information about the SFN included in the PDCCH if waking from a sleep state, and an SFN comparing unit to determine whether the SFN currently managed by the SFN managing unit is identical to an SFN of a network using the information about the SFN; and a base station, including: a PDCCH managing unit to check information about the SFN and to transmit the information about the SFN via the PDCCH to the mobile terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a structure of a mobile terminal to manage a system frame number (SFN) according to an exemplary embodiment of the present invention.

FIG. 2 illustrates a structure of a base station to provide an SFN according to an exemplary embodiment of the present invention.

FIG. 3 is a flowchart illustrating a process in which a mobile terminal manages an SFN according to an exemplary embodiment of the present invention.

FIG. 4 is a flowchart illustrating a process in which a base station provides an SFN according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is is thorough, and will fully convey the scope of the invention to those skilled in the art. In the drawings, the size and relative sizes of layers and regions may be exaggerated for clarity Like reference numerals in the drawings denote like elements.

Exemplary embodiments of the present invention provide an apparatus and a method for managing a system frame number (SFN), in which a difference in SFN between a base station and a mobile terminal is checked using information about an SFN included in a

Physical Downlink Control Channel a (PDCCH) if the mobile terminal reads the PDCCH in each discontinuous reception (DRX) cycle to inspect whether the mobile terminal received a paging message, and the difference in SFN is solved. A base station of a wireless communication system may allocate information about the SFN to the PDCCH and transmit the PDCCH.

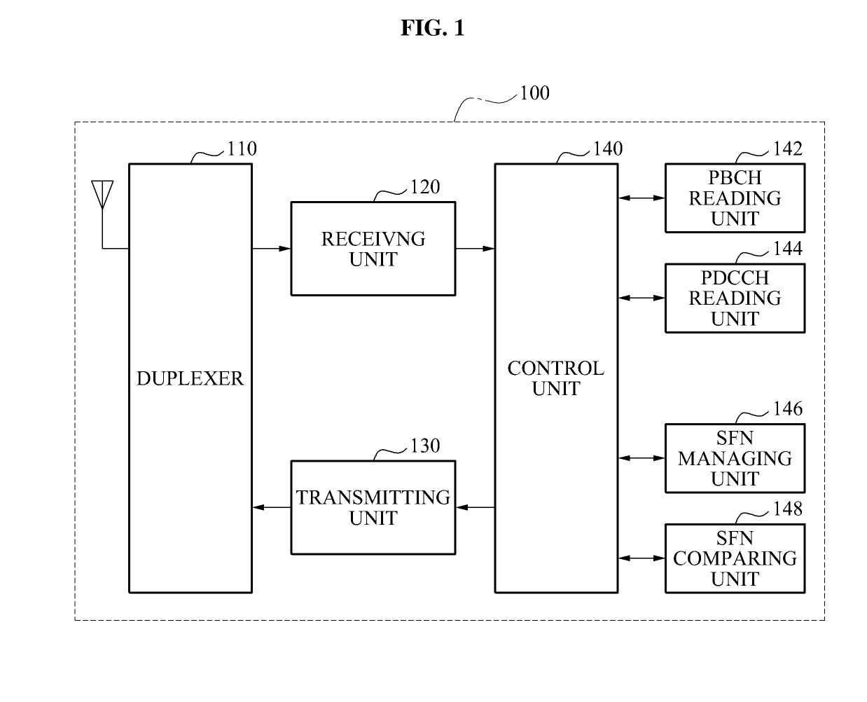

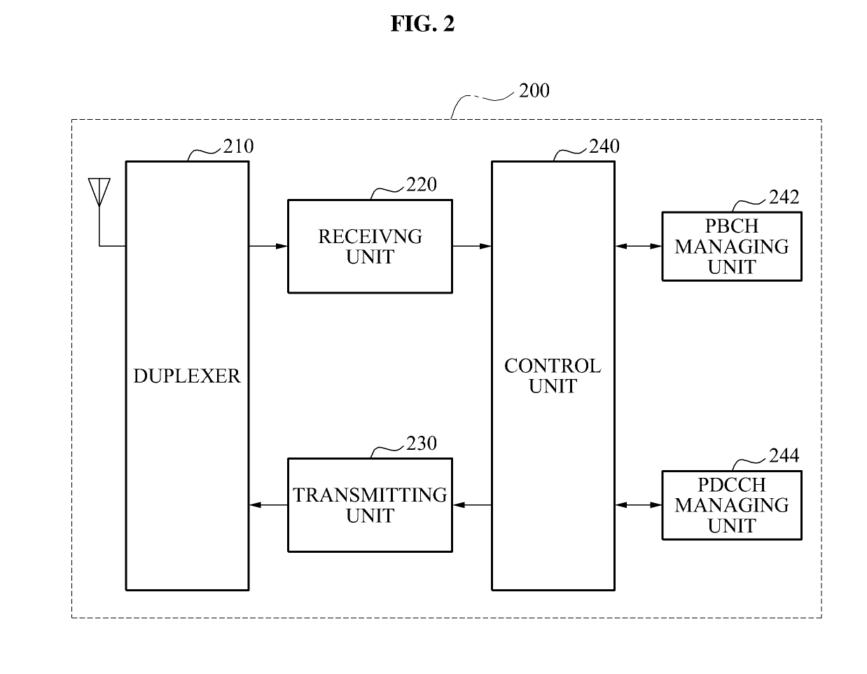

Hereinafter, structures of a mobile terminal and a base station to manage an SFN according to exemplary embodiments of the present invention are described with reference to FIGS. 1 and 2, respectively.

FIG. 1 illustrates a structure of a mobile terminal to manage an SFN according to an exemplary embodiment of the present invention. Referring to FIG. 1, the mobile terminal 100 may include a duplexer 110, a receiving unit 120, a transmitting unit 130, a control unit 140, a PBCH (Primary Broadcast Channel) reading unit 142, a PDCCH reading unit 144, an SFN managing unit 146, and an SFN comparing unit 148.

The duplexer 110 transmits a transmitting signal from the transmitting unit 130 via an antenna and transmits a receiving signal from the antenna to the receiving unit 120 in a duplex manner.

The receiving unit 120 converts the receiving signal received from the duplexer 110 into a baseband signal and transmits the baseband signal to the control unit 140. For example, in the case of orthogonal frequency division multiplexing (OFDM), the receiving unit 120 includes a radio frequency (RF) processor (not shown), an analog/digital converter (not shown), an OFDM demodulator (not shown), and a decoder (not shown). In this instance, the RF processor converts the high frequency signal received from the duplexer 110 into a baseband analog signal. The analog/digital converter converts the analog signal received from the RF processor into digital sample data and outputs the digital sample data. The OFDM demodulator converts the time-domain sample data received from the analog/digital converter into frequency-domain data through a fast Fourier transform. The decoder demodulates and decodes the signal received from the OFDM demodulator according to a preset demodulation level (MCS level) and outputs the signal.

The transmitting unit 130 converts the transmitting signal into a high frequency signal under the control of the control unit 140 and transmits the high frequency signal to the duplexer 110. For example, in the case of orthogonal frequency division multiplexing (OFDM), s the transmitting unit 130 may include a coder (not shown), an OFDM modulator (not shown), a digital/analog converter (not shown), and an RF processor (not shown). In this instance, the coder codes and modulates the transmitting signal according to a corresponding modulation level (MCS level), and outputs the signal. The OFDM modulator converts the frequency-domain data received from the coder into time-domain sample data (OFDM symbol) through a reverse fast io Fourier transform and outputs the time-domain sample data. The digital/analog converter converts the sample data received from the OFDM modulator into an analog signal and outputs the analog signal. The RF processor converts the baseband analog signal received from the digital/analog converter into a high frequency signal and outputs the high frequency signal.

The PBCH reading unit 142 reads a primary broadcast channel (PBCH), obtains is system information, and checks an SFN included in the system information.

The PDCCH reading unit 144 reads a downlink control channel (PDCCH) when the PBCH reading unit 142 wakes from a sleep state, checks information about an SFN included in the PDCCH, and checks P-RNTI (Paging Radio Network Temporary Identity) indicating whether the mobile terminal received a paging message. In this instance, information about the SFN may be the SFN or a result of dividing the SFN by a predetermined or specific value.

The SFN managing unit 146 stores the SFN checked by the PBCH reading unit 142 and adaptively changes and manages the SFN depending on changes in a clock.

The SFN comparing unit 148 determines whether the SFN currently managed by the SFN managing unit 146 is identical to an SFN of a network using information about the SFN checked by the PDCCH reading unit 144.

If the information about the SFN is a result of dividing the SFN by a predetermined or specific value, the SFN comparing unit 148 compares a result of dividing the SFN currently managed by the specific value with the information about the SFN checked by the PDCCH reading unit 144, and determines whether the results are identical to each other.

The control unit 140 controls the PBCH reading unit 142 to read an SFN again if the SFN comparing unit 148 determines that the SFN currently managed by the SFN managing unit 146 is not identical to the SFN of the network.

The control unit 140 determines whether a paging message exists through the P-RNTI checked by the PDCCH reading unit 144 if the SFN comparing unit 148 determines that the SFN currently managed by the SFN managing unit 146 is identical to the SFN of the network.

Also, the control unit 140 controls the operation of the mobile terminal 100. Although aspects of the present invention are described separately for ease of description, is aspects are not limited thereto such that the control unit 140 may perform all or portions of the operations of the PBCH reading unit 142, the PDCCH reading unit 144, the SFN managing unit 146 and the SFN comparing unit 148.

FIG. 2 illustrates a structure of a base station to provide an SFN according to an exemplary embodiment of the present invention. Referring to FIG. 2, the base station 200 may include a duplexer 210, a receiving unit 220, a transmitting unit 230, a control unit 240, a PBCH managing unit 242, and a PDCCH managing unit 244.

The duplexer 210 transmits a transmitting signal from the transmitting unit 230 via an antenna and transmits a receiving signal from the antenna to the receiving unit 220 in a duplex manner.

The receiving unit 220 converts the receiving signal received from the duplexer 210 into a baseband signal and transmits the baseband signal to the control unit 240. For example, in the case of orthogonal frequency division multiplexing (OFDM), the receiving unit 220 includes an RF processor (not shown), an analog/digital converter (not shown), an OFDM demodulator (not shown), and a decoder (not shown). In this instance, the RF processor converts the high frequency signal received from the duplexer 210 into a baseband analog signal. The analog digital converter converts the analog signal received from the RF processor into digital sample data and outputs the digital sample data. The OFDM demodulator converts the time-domain sample data received from the analog/digital converter into frequency-domain area data through a fast Fourier transform and outputs the frequency-domain data. The decoder demodulates and decodes the signal received from the OFDM demodulator according to a preset demodulation level (MCS level), and outputs the signal.

The transmitting unit 230 converts the transmitting signal into a high frequency signal under the control of the control unit 240 and transmits the high frequency signal to the duplexer 210. For example, in the case of orthogonal frequency division multiplexing (OFDM), the transmitting unit 230 includes a coder (not shown), an OFDM modulator (not shown), a digital/analog converter (not shown), and an RF processor (not shown). In this instance, the coder codes and modulates the transmitting signal according to a corresponding modulation level (MCS level) under the control of the control unit 240, and outputs the signal. The OFDM modulator converts the frequency-domain data received from the coder into time-domain sample data through a reverse fast Fourier transform, and outputs the time-domain sample data. The digital/analog converter converts the sample data received from the OFDM modulator into an analog signal and outputs the analog signal. The RF processor converts the baseband analog signal received from the digital/analog converter into a high frequency signal, and outputs the high frequency signal.

The PBCH managing unit 242 transmits system information including an SFN at a preset time interval via the PBCH.

The PDCCH managing unit 244 checks information about the SFN and transmits the information about the SFN via a PDCCH. In this instance, information about the SFN may be the SFN or a result of dividing the SFN by a predetermined or specific value.

The control unit 240 registers a location of a mobile terminal in a network if the control unit 240 receives a request for system registration from the mobile terminal in a cell area.

Also, the control unit 240 controls the operation of the base station 200. Although aspects of the present invention are described separately for ease of description, aspects are not limited thereto such that the control unit 140 may perform functions of the PBCH managing unit 242 and the PDCCH managing unit 244.

Hereinafter, a method for managing an SFN according to an exemplary embodiment of present invention is described with reference to the drawings as follows.

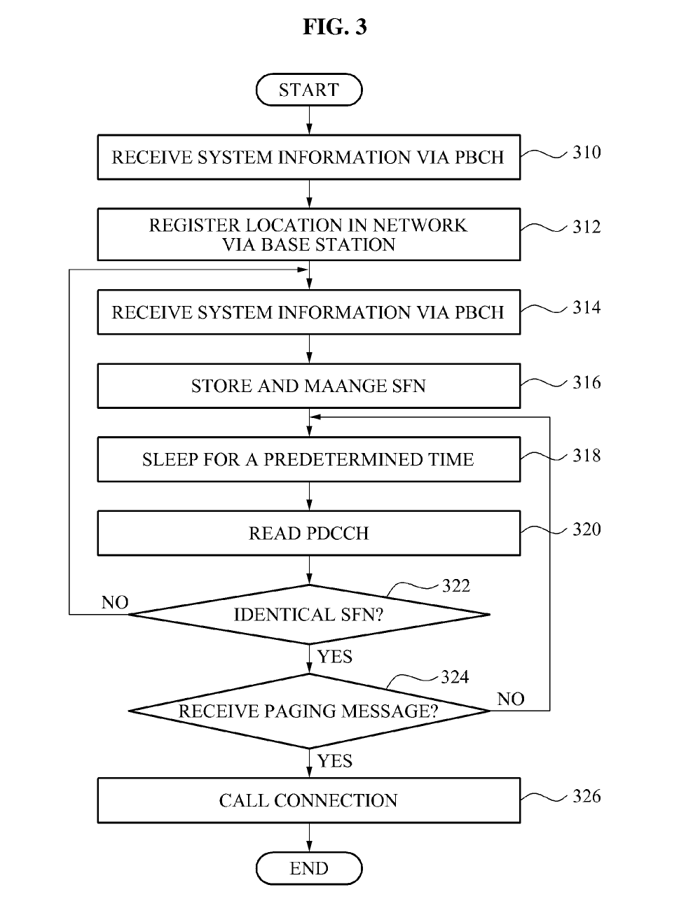

FIG. 3 is a flowchart illustrating a process in which a mobile terminal manages an SFN according to an exemplary embodiment of the present invention. Referring to FIG. 3, a mobile terminal receives system information via a PBCH in operation 310 and makes a request for location registration in a network via a base station in operation 312.

The mobile terminal receives the system information via the PBCH in operation 314. In operation 316, the mobile terminal stores an SFN included in the system information and manages the SFN such that the SFN changes depending on changes in clock.

The mobile terminal switches to a sleep state for a predetermined or specific time to perform discontinuous reception (DRX) in operation 318.

The mobile terminal reads a PDCCH if the mobile terminal wakes from the sleep state in operation 320.

The mobile terminal checks information about the SFN included in the PDCCH and determines whether the SFN currently managed is identical to an SFN of a network using the checked information about the SFN in operation 322. The information about the SFN may be the SFN or a result of dividing the SFN by a predetermined or specific value.

The mobile terminal returns to the operation 314 to receive an SFN again and repeats operation 314 to operation 322 if the SFN currently managed is not identical to the SFN of the network in operation 322.

If the SFN currently managed is identical to the SFN of the network in operation 322, the mobile terminal checks whether a paging message to the mobile terminal exists in operation 324. The mobile terminal returns to the operation 318 and repeats operation 318 to the is operation 324 if a paging message to the mobile terminal does not exist in operation 324. The mobile terminal provides a call connection service to a user of the mobile terminal in operation 326 if a paging message to the mobile terminal exists in operation 324.

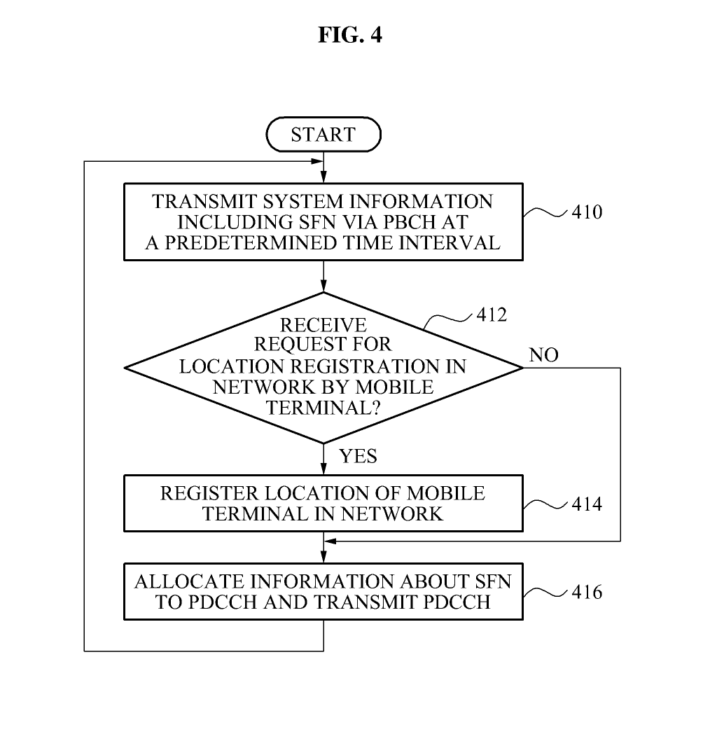

FIG. 4 is a flowchart illustrating a process in which a base station provides an SFN according to an exemplary embodiment of the present invention. Referring to FIG. 4, the base station transmits system information including an SFN at a predetermined or specific time interval via PBCH in operation 410.

The base station registers a location of a mobile terminal in a network in operation 414 if the base station receives a request for network registration from the mobile terminal in operation 412.

The base station allocates information about the SFN to a PDCCH and transmits the PDCCH in operation 416. In this instance, the information about the SFN may be the SFN or a result of dividing the SFN by a predetermined or specific value.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to manage a system frame number (SFN) in a mobile terminal, the apparatus comprising:
an SFN managing unit to manage an SFN;
a physical downlink control channel (PDCCH) reading unit to read a PDCCH and to check information about the SFN included in the PDCCH if waking from a sleep state; and
an SFN comparing unit to determine whether the SFN currently managed by the SFN managing unit is identical to an SFN of a network using the information about the SFN.

2. The apparatus of claim 1, further comprising:
a primary broadcast channel (PBCH) reading unit to receive the SFN currently managed via a PBCH.

3. The apparatus of claim 2, further comprising:
a control unit to control to receive an SFN again via the PBCH if the SFN comparing unit determines that the SFN currently managed is not identical to the SFN of the network.

4. The apparatus of claim 1, wherein the information about the SFN is the SFN or a result of dividing the SFN by a specific value.

5. The apparatus of claim 1, wherein the SFN comparing unit compares a result of dividing the SFN currently managed by a specific value with the information about the SFN, and determines whether the SFN currently managed and the SFN of the network are identical to each other.

6. The apparatus of claim 1, further comprising:
a control unit to check reception of a paging message if the SFN currently managed is identical to the SFN of the network.

7. An apparatus to manage a system frame number (SFN) in a base station, the apparatus comprising:
a physical downlink control channel (PDCCH) managing unit to check information about an SFN and to transmit the information about the SFN via a PDCCH.

8. The apparatus of claim 7, wherein the information about the SFN is the SFN or a result of dividing the SFN by a specific value.

9. The apparatus of claim 7, further comprising:
a primary broadcast channel (PBCH) managing unit to transmit the SFN via a PBCH at a specific time interval.

10. A method for managing a system frame number (SFN) in a mobile terminal, the method comprising:
reading a physical downlink control channel (PDCCH) if waking from a sleep state;
checking information about an SFN included in the PDCCH; and
determining whether the SFN currently managed is identical to an SFN of a network using the information about the SFN.

11. The method of claim 10, wherein the SFN currently managed is managed after being received via a primary broadcast channel (PBCH).

12. The method of claim 10, further comprising:
receiving an SFN via a PBCH and managing the SFN if the SFN currently managed is not identical to the SFN of the network.

13. The method of claim 10, wherein the information about the SFN is the SFN or a result of dividing the SFN by a specific value.

14. The method of claim 10, wherein the determination as to whether the SFN currently managed is identical to the SFN of the network comprises comparing a result of dividing the SFN currently managed by a specific value with the information about the SFN, and determining whether the SFN currently managed and the SFN of the network are identical to each other.

15. The method of claim 10, further comprising:
checking reception of a paging message if the SFN currently managed is identical to the information about the SFN.

16. A method for managing a system frame number (SFN) in a base station, the method comprising:
checking information about an SFN; and
transmitting the information about the SFN via a physical downlink control channel (PDCCH).

17. The method of claim 16, wherein the information about the SFN is the SFN or a result of dividing the SFN by a specific value.

18. The method of claim 16, further comprising:
transmitting the SFN via a primary broadcast channel (PBCH) at a specific time interval.

19. A wireless communication system to manage a system frame number (SFN), the system comprising:
a mobile terminal, comprising:
an SFN managing unit to manage an SFN,
a physical downlink control channel (PDCCH) reading unit to read a PDCCH and to check information about the SFN included in the PDCCH if waking from a sleep state, and
an SFN comparing unit to determine whether the SFN currently managed by the SFN managing unit is identical to an SFN of a network using the information about the SFN; and
a base station, comprising:
a PDCCH managing unit to check information about the SFN and to transmit the information about the SFN via the PDCCH to the mobile terminal.

20. The system of claim 20, wherein the mobile terminal receives an SFN again via a primary broadcast channel (PBCH) if the SFN comparing unit determines that the SFN currently managed is not identical to the SFN of the network.
